(19) United States
(12) Patent Application Publication
(10) Pub. No.: US 2021/0178816 A1
(43) Pub. Date: Jun. 17, 2021

(54) SYSTEMS AND METHODS FOR FORMING A MULTI-CORE SEMI-PNEUMATIC TIRE

(71) Applicant: Antego Tire & Wheel, Inc., Newman, GA (US)

(72) Inventor: Robert Graham, Newnan, GA (US)

(73) Assignee: Antego Tire & Wheel, Inc., Newnan, GA (US)

(21) Appl. No.: 16/716,152

(22) Filed: Dec. 16, 2019

(51) Int. Cl. B60C 7/12; B29D 30/02

(52) U.S. Cl. CPC B60C 7/125; B29D 30/02

(57) ABSTRACT

The present disclosure relates to multi-core semi-pneumatic tires and methods for manufacturing the same. In one exemplary embodiment, a semi-pneumatic tire includes an outer surface configured to contact ground; an inner surface configured to contact a wheel; and a plurality of hollow cores formed between the inner and outer surfaces in the semi-pneumatic tire, wherein each hollow core extends around a circumference of the tire.

### TECHNICAL FIELD

The present disclosure relates generally to the field of semi-pneumatic tires. More specifically, and without limitation, this disclosure relates to multi-core semi-pneumatic tires and methods for forming the same. The tires and formation techniques disclosed herein may be used in various applications and systems, such as lawnmowers, automotive vehicles, and other systems that benefit from semi-pneumatic tires.

### BACKGROUND

Semi-pneumatic tires typically comprise rubber surrounding a hollow core filled with air. The hollow core is an empty chamber that is intentionally formed within the body of the tire when it is manufactured and is not further pressurized with air. Unlike pneumatic tires, the hollow core is sealed during vulcanization and does not include any valves or bladders for refilling air in the core. Nevertheless, the hollow core is generally small enough such that the tire may continue to be used for a period of time after the tire has been punctured, e.g., before the tire needs to be replaced due to any shape deformity caused by continued use of the punctured tire. Accordingly, semi-pneumatic tires are often referred to as “run-flat” tires.

Existing constructions of semi-pneumatic tires are generally limited in size to widths (e.g., sidewall to sidewall) of 6.5 inches or less. One solution to this problem developed by Michelin® is an airless tire, marketed as a Tweel®, comprising a hub connected to the rim via flexible polyurethane spokes. Michelin's Tweel tires, however, are generally more costly than other conventional semi-pneumatic tires and are not cost-effective for applications such as industrial mowing or other high-mileage uses.

### SUMMARY

Embodiments of the present disclosure overcome the disadvantages of the prior art by providing multi-core semi-pneumatic tires and methods for forming such semi-pneumatic tires. By including multiple cores, the semi-pneumatic tires of the present disclosure may exceed the size limitations of existing semi-pneumatic tires, for example, having sizes up to or exceeding approximately 6.5 inch widths for tires with two hollow cores and even larger diameters for semi-pneumatic tires having more than two cores, such as up to or exceeding approximately 12 inch widths, 26 inch widths, or greater. The multi-core semi-pneumatic tires of the present disclosure are also more cost-effective compared with existing airless tires, such as the Tweel®.

Further, embodiments of the present disclosure provide methods for manufacturing multi-core semi-pneumatic tires. For example, by extruding rubber to form multiple hollow cores within the body of a semi-pneumatic tire, embodiments of the present disclosure can reduce the manufacturing time and costs compared with traditional semi-pneumatic tire-manufacturing processes. In some exemplary embodiments, the semi-pneumatic tire is constructed comprising two or more continuous hollow cores that extend in parallel around substantially the entire length of the tire's circumference. In such exemplary embodiments, adjacent parallel cores may be separated from each other within the tire by one or more rubber walls formed by the extruding process. Further to these exemplary embodiments, a method for manufacturing such a multi-core semi-pneumatic tire is also provided.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1A is a schematic representation of an exemplary multi-core semi-pneumatic tire, according to certain embodiments of the present disclosure.

FIG. 1B is a cross-section of the exemplary semi-pneumatic tire of FIG. 1A showing a plurality of cores, according to certain embodiments of the present disclosure.

FIG. 2 is another schematic representation of multiple cores for an exemplary semi-pneumatic tire, according to certain embodiments of the present disclosure.

FIG. 3A is a schematic representation of an exemplary extrusion apparatus with a mandrel that may be used for forming a multi-core rubber strip for a multi-core semi-pneumatic tire, according to certain embodiments of the present disclosure.

FIG. 3B is a schematic representation of an exemplary process for forming a semi-pneumatic tire using a multi-core rubber strip, according to certain embodiments of the present disclosure.

FIG. 4A is a schematic representation of an exemplary semi-pneumatic tire with three cores, according to certain embodiments of the present disclosure.

FIG. 4B is a schematic representation of an exemplary semi-pneumatic tire with four cores, according to certain embodiments of the present disclosure.

FIG. 5 is a flowchart of an exemplary method for forming a multi-core semi-pneumatic tire, according to certain embodiments of the present disclosure.

FIG. 6 is a flowchart of another exemplary method for forming a multi-core semi-pneumatic tire, according to certain embodiments of the present disclosure.

### DETAILED DESCRIPTION

The disclosed embodiments provide multi-core semi-pneumatic tires and methods for manufacturing the same. Advantageously, the exemplary embodiments disclose semi-pneumatic tire designs and manufacturing processes that can be more cost-effective for producing larger-width semi-pneumatic tires than is conventionally possible, such as tires with widths greater than 26 inches, or greater than 12 inches or at least greater than 6.5 inches. Embodiments of the present disclosure may be implemented and used in various applications and systems, such as but not limited to lawnmowers, automotive vehicles, golf carts, powersport vehicles, and any other vehicles or systems that may benefit from semi-pneumatic tires. Although exemplary embodiments of the present disclosure are generally described with reference to a single tire, it will be appreciated that the multi-core semi-pneumatic tires described in this disclosure may be part of, or integrated with, a larger assembly, such as containing at least one wheel, axel, or other component of a vehicle.

According to an aspect of the present disclosure, a semi-pneumatic tire may comprise a plurality of cores. In the exemplary embodiments, a “core” may refer to a hollow volume that extends along a circumferential direction of the tire. For example, a core may encompass the whole circumference of the tire. Also, as disclosed in the exemplary embodiments, the cores may be provided in any suitable size and shape for the tire. The multi-core tires of the exemplary embodiments are “semi-pneumatic” because each of their plurality of cores does not include any valves or other mechanisms for inserting pressurized air into the cores. Accordingly, the cores of the tires may be sealed from an environment external to the tire.

Additionally, in some embodiments, each core in the multi-core tire may be insulated from one or more adjacent cores by a material, such as rubber or a rubber-like material, that preferably may be formed within the body of the tire using an extruding process. For example, the same material that is used to form the outer portions and/or bulk of the tire also may be used to form one or more walls, partitions, diaphragms, or other separators between adjacent cores within the tire. In some embodiments, the material used to form the tire and its internal separators between adjacent cores preferably comprises any natural or synthetic rubber, including but not limited to isoprene polymers, chloroprene polymers, isobutylene polymers, styrene polymers, butadiene polymers, or any combination thereof. Accordingly, as used herein, the term “rubber-like” material refers to any natural or synthetic rubber material, including but not limited to the examples above.

According to another aspect of the present disclosure, a method for forming a semi-pneumatic tire using an extrusion process is described. For example, the method may include extruding a material, such as a rubber-like material, through a mold. In some exemplary embodiments, the mold preferably is shaped having a circular cross-section, where “circular” in this context may refer to a circle, an oval, an ellipse, or any other geometry with one or more rounded corners. The circular shape of the mold may enable the cross-section of the tire to be formed by extruding a rubber-like material through the mold. The extruded material may comprise a strip or other linear shape after it is extruded. In accordance with some embodiments, the extruded material may include a plurality of hollow volumes along its length for forming multiple cores when the strip or linearly shaped extruded material is further formed into a generally circular tire configuration.

To provide the multiple cores within the tire, in some embodiments the method may include inserting a plurality of hollow sections within the cross-section of the extruded material using a plurality of mandrels. Additionally or alternatively, the mold may include a plurality of mandrels held in place with legs or other supports. In any such embodiments, the extruded rubber-like material may include a plurality of hollow cores corresponding to the positioning of the plurality of mandrels. For example, if the extruded rubber-like material comprises a strip or other linear shape after extrusion, the hollow cores may extend along a length of the strip.

In embodiments where the extruded rubber-like material includes small gaps or holes corresponding to the positions of legs or other supports in the mold that impinge into the extruded material, the method may further include vulcanizing the extruded rubber-like material to seal such gaps or holes. For example, the material may be vulcanized using heat and/or chemicals such as sulfur.

In any of the exemplary embodiments described above, the manufacturing method may further include sealing the distal ends of the extruded rubber-like material together to form a circular shaped tire in which each of the plurality of hollow cores extends along a circumference of the tire. The process of sealing the ends of the extruded material together to form the tire also may comprise a vulcanization process using heat and/or chemicals such as sulfur. In some exemplary embodiments, the vulcanization process used to seal the distal ends of the extruded material together to form a circular shaped tire may employ the same vulcanization process that is also used to seal small gaps in the extruded material, as described above, or may employ a different vulcanization process.

Additionally or alternatively, sealing the distal ends of the extruded material to form the circular tire configuration may comprise using one or more adhesives. For example, one or more rubber-based adhesives may seal the distal ends together, either permanently or before vulcanization.

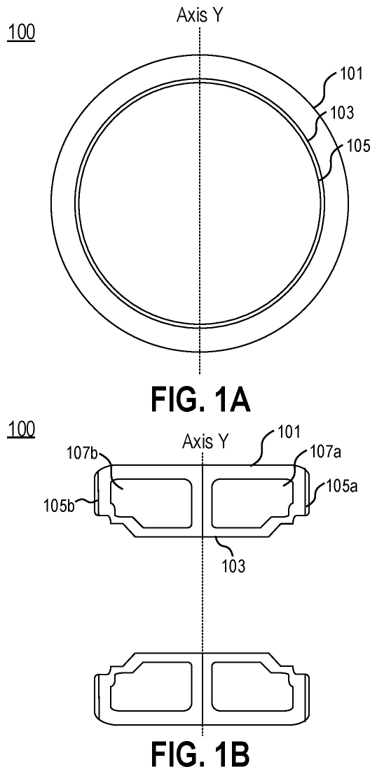

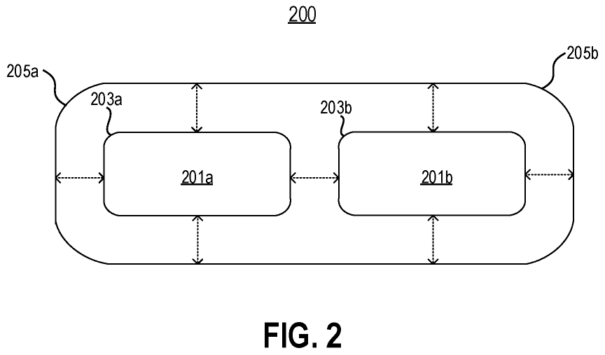

FIG. 1A is a schematic representation of an exemplary tire 100, consistent with certain embodiments of the present disclosure. As shown in the example of FIG. 1A, tire 100 includes an outer surface 101 configured to contact the ground (not shown) as the tire rotates. Moreover, tire 100 also includes an inner surface 103 configured to contact a wheel (not shown) around which tire 100 is wrapped. In some embodiments, tire 100 may further include one or more beads 105 along the outer edges of the inner surface 103 to secure the tire 100 to the wheel, e.g., along a rim of the wheel. In other embodiments not shown in FIG. 1A, inner surface 103 may contact the wheel directly without the use of beads 105.

FIG. 1B depicts a cross-sectional view of tire 100 along axis Y, consistent with certain exemplary embodiments. As shown in FIG. 1B, tire 100 comprises at least two cores 107a and 107b between inner surface 103 and outer surface 101. Beads 105 are shown as a front bead 105a and a back bead 105b in the cross-section of FIG. 1B, although any number of beads, or even no beads, may be used.

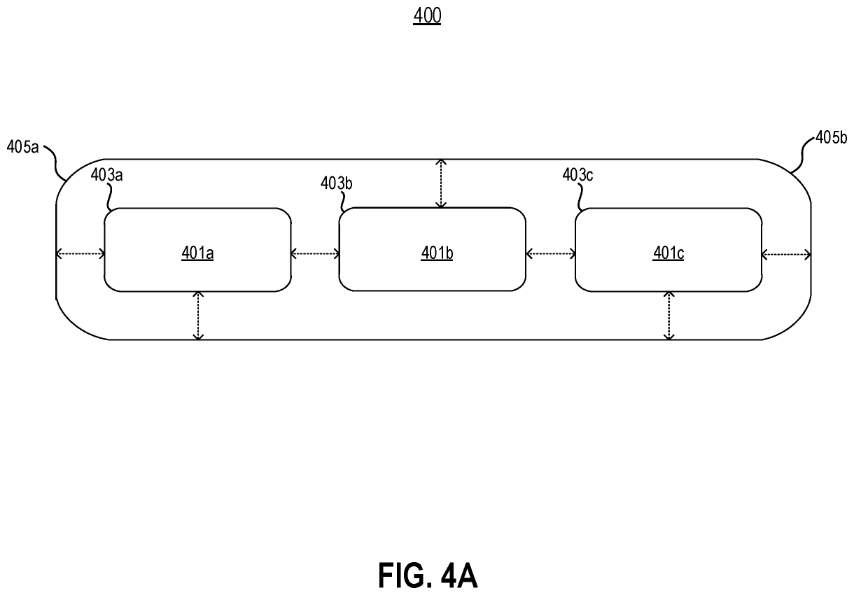

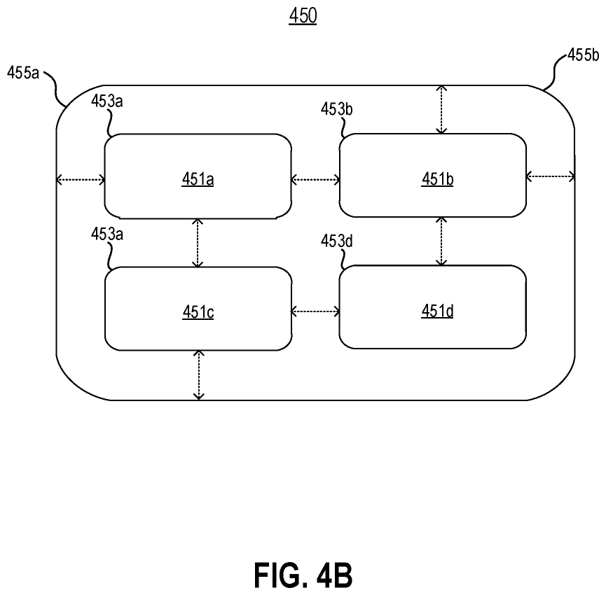

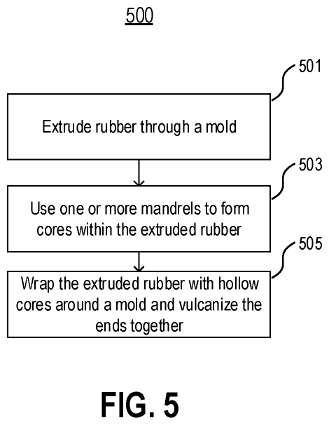

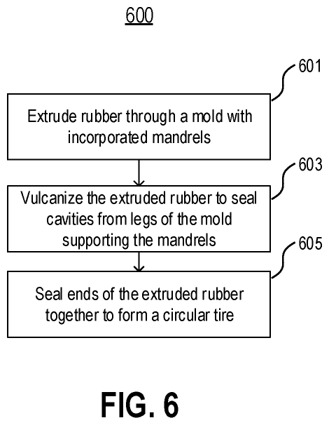

Cores 107a and 107b may comprise residual air that has been trapped in each core during the manufacturing process of forming the tire 100, e.g., using one or more of the exemplary manufacturing processes of FIGS. 5 and 6. Although depicted with two cores (see also FIG. 2), the tire 100 alternatively may include any number of two or more cores, such as three cores as shown in FIG. 4A, or four cores as depicted in FIG. 4B, or more cores.

Moreover, cores 107a and 107b may comprise irregular shapes, for example, to fit the shape of a particular wheel. For example, as FIG. 1B shows, the exemplary cores 107a and 107b may have at least one dimension (e.g., height) that is longer near the center of tire 100 and shorter near the edges of tire 100. In other embodiments, the cores 107a and 107b may comprise circular shapes, e.g., as depicted in FIG. 2, rectangular shapes, or any other cross-sectional shapes. The shapes and positions of each core within the tire 100 may be separately selected, for example, based on a typical load that may be applied to the tire, a desired weight for the tire, and/or other environmental or operational factors that may be specific for a particular application or system using the tire.

FIG. 2 is a schematic representation of a semi-pneumatic tire 200 that includes a plurality of cores, consistent with certain embodiments of the present disclosure. As shown in the example of FIG. 2, the tire 200 may include at least two cores 201a and 201b; however, in other embodiments, tire 200 may include additional cores, such as three cores as depicted in FIG. 4A, or four cores as depicted in FIG. 4B, or more. In this example, the cores 201a and 201b of FIG. 2 may correspond to the cores 107a and 107b in FIG. 1B. Further, in some exemplary embodiments, the cores 201a and 201b have substantially the same shapes and the position of these cores may be substantially symmetric about the center of the tire's cross-sectional area (e.g., depicted as axis Y in FIGS. 1A and 1B).

In the example of FIG. 2, both the tire 200 and its cores 201a and 201b have circular cross-sections. Accordingly, the curvatures of rounded corners 205a and 205b of the tire 200 may comprise multiples, fractions, or other functions of the curvatures of the rounded corners 203a and 203b of the cores 201a and 201b, respectively. Although not labeled in FIG. 2, the curvatures of additional rounded corners of tire 200 may similarly comprise multiples, fractions, or other functions of the curvatures of additional rounded corners of cores 201a and 201b.

Additionally or alternatively, as shown in FIG. 2, the spacing between cores 201a and 201b as well as the spacing between the cores and an outer surface of tire 200 may comprise multiples, fractions, or other functions of each other. In the example of FIG. 2, the spacing between cores 201a and 201b is equal to the spacing between surfaces of cores 201a and 201b and nearby outer surfaces of tire 200. In other embodiments, these spacings need not be equal but instead may be any multiple, fraction, or other function of each other.

Although not depicted in FIG. 2, additional dimensioning may include selecting the lengths (not including the rounded corners) of cores 201a and 201b as fractions or other functions of the length (not including the rounded corners) of tire 200. Additionally or alternatively, additional dimensioning may include selecting the heights (not including the rounded corners) of cores 201a and 201b as fractions or other functions of the height (not including the rounded corners) of tire 200.

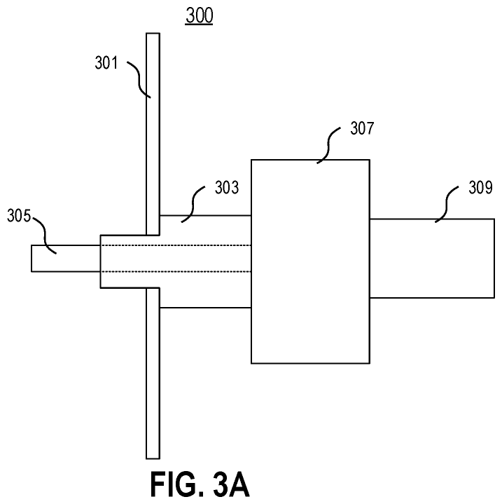

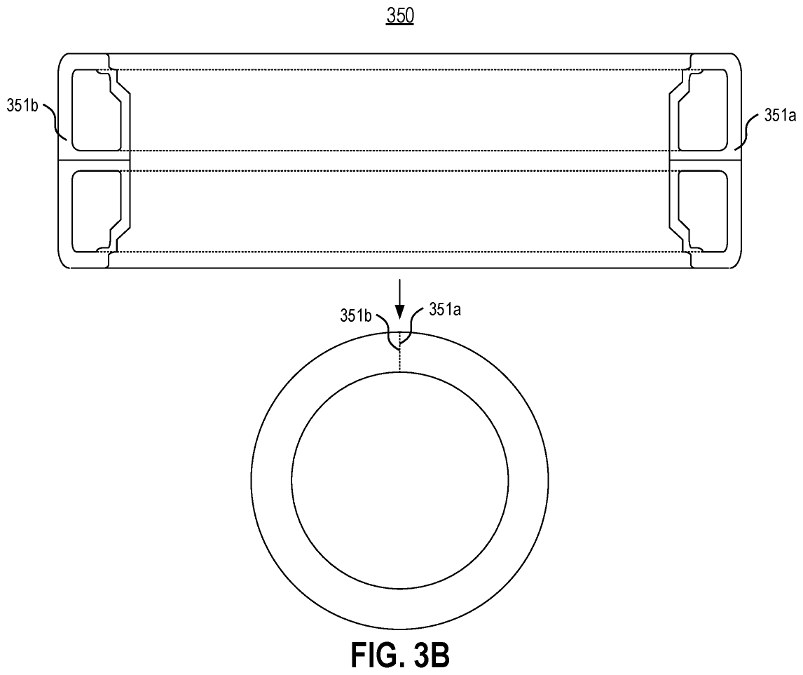

FIG. 3A depicts an exemplary extrusion process 300 for forming a multi-core semi-pneumatic tire, e.g., tire 100 of FIGS. 1A and 1B, tire 200 of FIG. 2, or the like, consistent with certain embodiments of the present disclosure. As shown in the example of FIG. 3A, a rubber-like material 303 is forced through mold 301 to form a strip or other linear shape of extruded material. Moreover, mandrel 305, for example attached to a dummy block 307, forms a core within the rubber-like material 303 as the material is extruded through mold 301 and around the mandrel 305. In this example, a ram or piston 309 may control the speed and relative movement of the dummy block 307 and therefore control the movement of the mandrel 305. Those skilled in the art will appreciate other extruding apparatuses and systems could be used as an alternative to the example of FIG. 3A.

In other embodiments (not shown in FIG. 3A), for example, the mandrel 305 may comprise a floating mandrel protruding from a slot in the dummy block 307. In such embodiments, the speed of mandrel 305 may be controlled independently from the speed of the ram or piston 309.

As an alternative to the use of a fixed or floating mandrel 305, some embodiments may incorporate the mandrel 305 into the mold 301 using legs or other supports. These legs or supports may result in small gaps or hollow spaces in the extruded rubber-like material 303 such that the hollow core formed by the mandrel 305 may not be sealed. Accordingly, to form a semi-pneumatic tire with a sealed core, any small gaps that may have been formed by the legs in the extrusion process may be closed using a vulcanization process, e.g., as discussed with respect to FIG. 3B or by using a separate and additional vulcanization process.

Although described with respect to a single core, the techniques shown in FIG. 3A and discussed herein with reference to FIG. 3A may be used to form any number of cores. For example, additional mandrels 305 may be incorporated during the extrusion process to form additional cores, e.g., using a different mandrel 305 for each hollow core that is formed as the rubber-like material is extruded.

FIG. 3B depicts an exemplary molding process 350 for converting an extruded material having multiple cores into a circular configuration to form a semi-pneumatic tire, e.g., such as the tire 100 of FIGS. 1A and 1B, tire 200 of FIG. 2, or the like, consistent with certain embodiments of the present disclosure. The process 350 may be used after the extrusion process 300 of FIG. 3A. As shown in the example of FIG. 3B, a strip of rubber-like material having multiple cores formed using an extrusion process may have two distal ends 351a and 351b. The strip of rubber-like material may be formed into a circular shape and ends 351a and 351b aligned and joined. Joining the ends 351a and 351b will form the circular shaped tire with an inner surface and outer surface and may be sealed using adhesives and/or a vulcanization process to close off the cores from the environment. Accordingly, residual air in the cores may be trapped during the process of joining the distal ends 351a and 351b. In other embodiments, a vacuum or partial vacuum may be applied to the cores before and/or during joining of the ends 351a and 351b. In yet other alternative embodiments, one or more of the cores may be filled with a polymeric foam or other material to provide additional structural or load-bearing support.

As discussed above, the process of joining the ends 351a and 351b together may include use of one or more adhesives, such as rubber-based adhesives, optionally also using a vulcanization process using heat and/or chemicals such as sulfur. Although not depicted in FIG. 3B, the extruded rubber-like strip may be wrapped around a circular mold or a wheel prior to application of adhesive(s) and/or vulcanization to secure the alignment and shape of the tire before the ends 351a and 351b are joined to form the tire. In such embodiments, the circular mold (not shown) may set the circular shape for the resultant tire. The ends 351a and 351b are preferably aligned so the multiple cores within the rubber-like material form continuous hollow cores around the tire after the ends 351a and 351b have been joined together to form the tire.

FIG. 4A is a schematic representation of an exemplary semi-pneumatic tire 400 with three cores, consistent with certain embodiments of the present disclosure. As shown in the example of FIG. 4A, a tire 400 may include at least three cores 401a, 401b, and 401c. As depicted in FIG. 4A, cores 401a, 401b, and 401c may form a line along a cross-section of tire 400; however, in other embodiments, cores 401a, 401b, and 401c may form a triangular or other shape on the cross-sectional area of tire 400. While the exemplary cores 401a, 401b, and 401c are shown with substantially the same cross-sectional areas, other embodiments (not shown) may select different cross-sectional areas for these cores, for example, where the central core 401b may have a different cross-sectional area than the outer cores 401a and 401c.

In the example of FIG. 4A, both the tire 400 and cores 401a, 401b, and 401c have circular cross-sections. Accordingly, the curvatures of rounded corners 405a and 405b of tire 400 may comprise multiples, fractions, or other functions of the curvatures of rounded corners 403a, 403b, and 403c of cores 401a, 401b, and 401c, respectively. Although not labeled in FIG. 4A, the curvatures of additional rounded corners of tire 400 may similarly comprise multiples, fractions, or other functions of the curvatures of additional rounded corners of cores 401a, 401b, and 401c.

Additionally or alternatively, as shown in FIG. 4A, the spacing between cores 401a, 401b, and 401c as well as the spacing between the cores 401a, 401b, and 401c and an outer surface of tire 400 may comprise multiples, fractions, or other functions of each other. In the example of FIG. 4A, the spacing between cores 401a, 401b, and 401c is equal to the spacing between surfaces of cores 401a, 401b, and 401c and nearby outer surfaces of tire 400. In other embodiments, these spacings need not be equal but instead may be any multiple, fraction, or other function of each other.

Although not depicted in FIG. 4A, additional dimensioning may include selecting the lengths (not including the rounded corners) of cores 401a, 401b, and 401c as fractions or other functions of the length (not including the rounded corners) of tire 400. Additionally or alternatively, additional dimensioning may include selecting the heights (not including the rounded corners) of cores 401a, 401b, and 401c as fractions or other functions of the height (not including the rounded corners) of tire 400.

FIG. 4B is a schematic representation of an exemplary semi-pneumatic tire 450 with four cores, consistent with certain embodiments of the present disclosure. As shown in the example of FIG. 4B, tire 450 may include at least four cores 451a, 451b, 451c, and 451d. As depicted in FIG. 4B, cores 451a, 451b, 451c, and 451d may form a rectangular shape on a cross-section of tire 450; however, in other embodiments, cores 451a, 451b, 451c, and 451d may form a linear or other shape on the cross-section of tire 450.

In the example of FIG. 4B, both a tire 450 and cores 451a, 451b, 451c, and 451d have circular cross-sections. Accordingly, the curvatures of rounded corners 455a and 455b of tire 450 may comprise multiples, fractions, or other functions of the curvatures of rounded corners 453a, 453b, 453c, and 453d of cores 451a, 451b, 451c, and 451d, respectively. Although not labeled in FIG. 4B, the curvatures of additional rounded corners of tire 450 may similarly comprise multiples, fractions, or other functions of the curvatures of additional rounded corners of cores 451a, 451b, 451c, and 451d.

Additionally or alternatively, as shown in FIG. 4B, the spacing between cores 451a, 451b, 451c, and 451d as well as the spacing between the cores 451a, 451b, 451c, and 451d and an outer surface of tire 450 may comprise multiples, fractions, or other functions of each other. In the example of FIG. 4B, the horizontal and vertical spacings between cores 451a, 451b, 451c, and 451d are equal to the spacing between surfaces of cores 451a, 451b, 451c, and 451d and nearby outer surfaces of tire 450. In other embodiments, these spacings need not be equal but instead may be any multiple, fraction, or other function of each other.

Although not depicted in FIG. 4B, additional dimensioning may include selecting the lengths (not including the rounded corners) of cores 451a, 451b, 451c, and 451d as fractions or other functions of the length (not including the rounded corners) of tire 450. Additionally or alternatively, additional dimensioning may include selecting the heights (not including the rounded corners) of cores 451a, 451b, 451c, and 451d as fractions or other functions of the height (not including the rounded corners) of tire 450.

Although FIGS. 4A and 4B depicts examples of three- and four-core semi-pneumatic tires, embodiments of the present disclosure may include further cores, such as five, six, or even more cores. The sizes of tires formed according to the present disclosure may increase in proportion to the number of cores used.

Any of the semi-pneumatic tires described herein may be formed according to suitable manufacturing processes. For example, FIG. 5 is a flowchart depicting an exemplary method 500 for manufacturing a semi-pneumatic tire, e.g., any of the tires in FIG. 1A, 1B, 2, 4A, or 4B. At step 501, method 500 may include extruding a rubber-like material through a mold, e.g., as depicted in FIG. 3A. The mold may be shaped with a circular cross-section, e.g., such as the cross-sections of tire 200 of FIG. 2, tire 400 of FIG. 4A, tire 450 of FIG. 4B, or the like.

In some embodiments, the rubber-like material used in the extrusion process of step 501 may comprise any natural or synthetic rubber. For example, the rubber-like material may comprise one or more of isoprene polymers, chloroprene polymers, isobutylene polymers, styrene polymers, or butadiene polymers. In some embodiments, the rubber-like material may comprise monomers of isoprene, chloroprene, isobutylene, styrene, and/or butadiene that are polymerized (and/or co-polymerized) during vulcanization, e.g., in step 505 of method 500.

At step 503, method 500 may include creating a plurality of hollow cores within a cross-section of the extruded rubber-like material using a plurality of mandrels. Each mandrel may be used to form a respective hollow core. For example, as depicted in FIG. 3A, a plurality of mandrels fixed to a dummy block used for the extrusion of the rubber-like material may form the plurality of hollow sections during extrusion. Accordingly, in such embodiments, step 503 may include aligning fixed mandrels on the dummy block along desired locations for the plurality of hollow sections on the rubber-like material.

In other embodiments, a plurality of mandrels in a slot of a dummy block used for the extrusion of the rubber-like material may form the plurality of hollow sections during extrusion. Accordingly, in such embodiments, step 503 may include aligning floating mandrels on the dummy block along desired locations for the plurality of hollow sections on the rubber-like material and controlling the floating mandrels independently of a ram moving the dummy block.

In some exemplary embodiments, method 500 may further include piercing the extruded rubber-like material before inserting the plurality of mandrels. The piercing may be performed using a separate device or apparatus. Those skilled in the art will also appreciate that the mandrels may be replaced with any other suitable component that may be used to create the hollow cores in the extruded rubber-like material in accordance with the exemplary embodiments herein.

At step 505, method 500 may include wrapping the extruded strip of rubber-like material around a circular mold or wheel, aligning the distal ends of the strip, including for example the hollow cores formed in the extruded material, and joining the distal ends together to form a circular shaped tire with multiple cores. In this manner, each of the plurality of hollow cores in the extruded material may extend along a circumference of the circular tire. For example, as described with reference to FIG. 3B, vulcanizing the distal ends of the extruded material may comprise placing the extruded rubber-like material in a tire mold and using at least one of heat or chemicals to cure the extruded rubber-like material. Additionally or alternatively, step 505 may include sealing the ends of the extruded rubber-like material together using one or more adhesives. For example, step 505 may include using the one or more adhesives before using at least one of heat or chemicals to cure the material.

The exemplary method 500 also may include additional steps. For example, in some embodiments, method 500 may include inspecting the tire, e.g., using x-rays, magnetic resonance imaging (MRI), or the like. Additionally or alternatively, method 500 may include performing one or more mechanical tests on the tire, such as stress tests, tread tests, road tests, or the like.

FIG. 6 is a flowchart depicting another exemplary method 600 for manufacturing a semi-pneumatic tire, e.g., any of the tires depicted in FIG. 1A, 1B, 2, 4A, or 4B. Method 600 may be used as an alternative to or in combination with method 500, in any of the exemplary embodiments described below or any combinations of such embodiments.

At step 601, method 600 may include extruding a rubber-like material through a mold. The mold may be shaped with a circular cross-section, e.g., such as the exemplary cross-sections of the tire 200 of FIG. 2, tire 400 of FIG. 4A, tire 450 of FIG. 4B, or the like. The mold may further include a plurality of mandrels held in place with one or more legs.

In some embodiments, the rubber-like material used in the method 600 may comprise any natural or synthetic rubber. For example, the rubber-like material may comprise one or more of isoprene polymers, chloroprene polymers, isobutylene polymers, styrene polymers, or butadiene polymers. In some embodiments, the rubber-like material may comprise monomers of isoprene, chloroprene, isobutylene, styrene, and/or butadiene that are polymerized (and/or co-polymerized) during vulcanization, e.g., in step 505 of method 500.

At step 603 in FIG. 6, method 600 may include vulcanizing the extruded rubber-like material to seal small gaps or holes in the extruded rubber-like material based on where one or more legs or other supports impinged the extruded material during the extrusion process. For example, vulcanizing to seal such small gaps or holes may comprise using at least one of heat or chemicals to cure the extruded rubber-like material.

At step 605, the method 600 may include sealing the distal ends of the extruded rubber-like material together to form a circular shaped tire. After the ends have been joined together, each of a plurality of hollow cores formed by the plurality of mandrels may extend along a circumference of the tire. For example, sealing the ends of the extruded material may comprise using one or more adhesives to connect the ends. Additionally or alternatively, as depicted in FIG. 3B, step 605 may include placing the extruded rubber-like material in a circular tire mold or wheel and using at least one of heat or chemicals to cure the extruded rubber-like material. For example, step 605 may include using the one or more adhesives before using at least one of heat or chemicals to cure the material.

Step 605 may include a vulcanization process distinct from step 603. Alternatively, steps 603 and 605 may comprise the same vulcanization process.

Methods 500 and 600 may be combined. For example, method 600 may include step 505 of method 500 in addition with or in lieu of step 605 for connecting the ends of the extruded rubber-like material together. Similarly, method 500 may include step 505 of method 500 in addition with or in lieu of step 605 for connecting the ends of the extruded rubber-like material together.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include certain exemplary manufacturing components and apparatuses, but systems and methods consistent with the present disclosure can be implemented with other manufacturing apparatuses, including for example both hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A semi-pneumatic tire comprising:
an outer surface configured to contact the ground;
an inner surface configured to contact a wheel; and
a plurality of hollow cores formed between the inner and outer surfaces in the semi-pneumatic tire, wherein each hollow core extends around a circumference of the tire.

2. The semi-pneumatic tire of claim 1, wherein the tire is formed from a rubber-like material comprising one or more of natural rubber, isoprene polymers, chloroprene polymers, isobutylene polymers, styrene polymers, or butadiene polymers.

3. The semi-pneumatic tire of claim 1, wherein the width of the tire is greater than 6.5 inches.

4. The semi-pneumatic tire of claim 3, wherein the width of the tire is greater than 12 inches.

5. The semi-pneumatic tire of claim 1, wherein the plurality of hollow cores comprise three or more hollow cores.

6. The semi-pneumatic tire of claim 5, wherein the plurality of hollow cores are arranged linearly along a cross-sectional area of the tire.

7. The semi-pneumatic tire of claim 1, wherein the plurality of hollow cores comprise four or more hollow cores.

8. The semi-pneumatic tire of claim 7, wherein the plurality of hollow cores are arranged symmetrically about a center of a cross-sectional area of the tire.

9. A method for manufacturing a semi-pneumatic tire comprising:
extruding a rubber-like material through a mold, wherein the mold is shaped with a circular cross-section, the extruded rubber-like material have a pair of distal ends;
creating a plurality of hollow sections within the cross-section of the extruded rubber-like material;
aligning the distal ends of the extruded rubber-like material to form a circular shape for the extruded rubber-like material; and
vulcanizing distal ends of the extruded rubber-like material together to form a tire, wherein each of the plurality of hollow sections extends along a circumference of the tire.

10. The method of claim 9, wherein the rubber-like material comprises one or more of natural rubber, isoprene polymers, chloroprene polymers, isobutylene polymers, styrene polymers, or butadiene polymers.

11. The method of claim 9, wherein the plurality of hollow sections are formed using a plurality of mandrels, and the method further comprises aligning fixed mandrels on a dummy block along desired locations for the plurality of hollow sections on the rubber-like material.

12. The method of claim 9, wherein the plurality of hollow sections are formed using a plurality of mandrels, and the method further comprises aligning floating mandrels on a dummy block along desired locations for the plurality of hollow sections on the rubber-like material and controlling the floating mandrels independently of a ram moving the dummy block.

13. The method of claim 9, further comprising piercing the rubber-like material before inserting a plurality of mandrels.

14. The method of claim 9, wherein vulcanizing the distal ends comprises placing the extruded rubber-like material in a tire mold and using at least one of heat or chemicals to cure the extruded rubber-like material.

15. The method of claim 9, further comprising sealing the distal ends of the extruded rubber-like material together using one or more adhesives.

16. A method for manufacturing a semi-pneumatic tire comprising:
extruding a rubber-like material through a mold, wherein the mold is shaped with a circular cross-section and includes a plurality of mandrels held in place with legs;
vulcanizing the extruded rubber-like material to seal gaps in the extruded rubber-like material corresponding to the legs; and
sealing a pair of distal ends of the extruded rubber-like material together to form a tire, wherein each of a plurality of hollow sections formed by the plurality of mandrels extends along a circumference of the tire.

17. The method of claim 16, wherein the rubber-like material comprises one or more of natural rubber, isoprene polymers, chloroprene polymers, isobutylene polymers, styrene polymers, or butadiene polymers.

18. The method of claim 16, wherein vulcanizing to seal gaps comprises using at least one of heat or chemicals to cure the extruded rubber-like material.

19. The method of claim 16, wherein sealing the pair of distal ends of the extruded rubber-like material together comprises placing the extruded rubber-like material in a tire mold and using at least one of heat or chemicals to cure the extruded rubber-like material.

20. The method of claim 16, wherein sealing the pair of distal ends of the extruded rubber-like material together comprises using one or more adhesives.
